(19) United States
(12) Patent Application Publication
(10) Pub. No.: US 2023/0393086 A1
(43) Pub. Date: Dec. 7, 2023

(54) COMBUSTION MONITORING DEVICE AND COMBUSTION MONITORING PROGRAM

(71) Applicant: Azbil Corporation, Tokyo (JP)

(72) Inventors: Shigeki ISHII, Tokyo (JP); Takeshi NISHIYAMA, Tokyo (JP); Daisuke OKUMURA, Tokyo (JP); Kenichi YAMAGATA, Tokyo (JP)

(73) Assignee: Azbil Corporation, Tokyo (JP)

(21) Appl. No.: 18/197,037

(22) Filed: May 13, 2023

(30) Foreign Application Priority Data
Jun. 2, 2022 (JP) 2022-090137

(51) Int. Cl. G01N 25/22; F23N 5/24

(52) U.S. Cl. CPC G01N 25/22; F23N 5/242

(57) ABSTRACT

A user is allowed to appropriately recognize a malfunction in a combustion device by a combustion monitoring device, which includes an information acquisition unit that acquires a plurality of sets each including an amount of fuel supplied to a main burner of a combustion device and an average value and a variation degree of flame levels when the amount of fuel is supplied to the main burner. The combustion monitoring device further includes information processing unit that executes a process of displaying, on a display, a graph indicating a relation between the amount of fuel and the average value of the flame levels, and a graph indicating a relation between the amount of fuel and the variation degree of the flame levels, based on the plurality of sets acquired by the information acquisition unit.

### CROSS REFERENCE TO RELATED APPLICATIONS

This patent application claims the benefit of foreign priority to Japanese Patent Application No. JP 2022-090137 filed on Jun. 2, 2022, the disclosure of which is herein incorporated by reference in its entirety.

### BACKGROUND OF THE INVENTION

The present disclosure relates to a combustion monitoring device and a combustion monitoring program for monitoring a combustion device.

Japanese Patent Application Publication No. JP 2019-060573 A (“JP '573 ”) discloses a technique for monitoring an active degree (a flame voltage in JP '573) of a flame of a burner for each of a plurality of subsequences (in JP '573, “pilot ignition (trial)”, “pilot only”, “main ignition”, and “main stabilization”) constituting a combustion sequence. In this technique, when the active degree of the flame of the burner to be monitored deviates from a predetermined range defined for each subsequence, it is determined that a malfunction has occurred in a combustion device. By checking a determination result, a user can recognize that a malfunction has occurred in the combustion device.

### BRIEF SUMMARY OF THE INVENTION

Since only the active degree of the flame of the burner is monitored by the technique described in JP '573, the user may not appropriately recognize the malfunction of the combustion device. This it because, for example, it is conceivable that there may be a type of malfunction that cannot be recognized by monitoring only the active degree of the flame.

The present disclosure has been made in view of the above points, and an aspect thereof is to allow a user to appropriately recognize a malfunction of a combustion device.

In order to solve the above problem, a combustion monitoring device according to the present disclosure includes: an information acquisition unit configured to acquire a plurality of sets each including an amount of fuel supplied to a burner of a combustion device and at least one of a magnitude of an active degree of a flame of the burner when the amount of fuel is supplied to the burner and a variation degree of the active degree; and an information processing unit configured to execute a process of displaying, on a display unit, a graph indicating a relation between the amount of fuel and at least one of the magnitude and the variation degree based on the plurality of sets acquired by the information acquisition unit.

The active degree may be represented by the number of flame detector discharges per unit time caused by the flame of the burner.

Each of the plurality of sets may include both the magnitude and the variation degree, and the graph may include a first graph in which the amount of fuel and the magnitude are plotted in a coordinate system having the amount of fuel as a first axis and the magnitude as a second axis, and a second graph in which the amount of fuel and the variation degree are plotted in a coordinate system having the amount of fuel as a first axis and the variation degree as a second axis.

Each of the first graph and the second graph may show a normal range when the combustion device is normal.

The information acquisition unit may acquire a plurality of sets each including the amount of fuel, the magnitude, and the variation degree when the combustion device is normal, and the information processing unit may specify the normal range based on the plurality of sets.

The graph may be a graph in which the plurality of sets are plotted on a coordinate system having the amount of fuel as a first axis and at least one of the magnitude and the variation degree, as a second axis, the information processing unit may plot the plurality of sets on the coordinate system using a plurality of graphics, and the plurality of graphics may be translucent such that when the graphics are plotted in an overlapping manner, a color of an overlapped portion is dark.

Each of the plurality of sets may include both the magnitude and the variation degree, and the graph may include a trend graph representing a temporal change in each of the amount of fuel, the magnitude, and the variation degree.

The information processing unit may determine that the combustion device is not normal when a predetermined number or more sets of the plurality of sets are outside a predetermined normal range, and may output the determination.

A combustion monitoring program according to the present disclosure causes a computer to execute: an information acquisition step of acquiring a plurality of sets each including an amount of fuel supplied to a burner of a combustion device and at least one of a magnitude of an active degree of a flame of the burner when the amount of fuel is supplied to the burner and a variation degree of the active degree; and an information processing step of executing a process of displaying, on a display unit, a graph indicating a relation between the amount of fuel and at least one of the magnitude and the variation degree based on the plurality of sets acquired in the information acquisition step.

The information processing step may include a step of determining that the combustion device is not normal when a predetermined number or more sets of the plurality of sets are outside a predetermined normal range, and outputting the determination.

According to the present disclosure, a user can appropriately recognize a malfunction of a combustion device.

### BRIEF DESCRIPTION OF THE SEVERAL VIEWS OF THE DRAWING

FIG. 1 is a configuration diagram of a heating system including a combustion monitoring device according to an embodiment of the present disclosure.

FIG. 2 is a flowchart of a combustion sequence executed by a combustion control device.

FIG. 3 is a hardware configuration diagram of the combustion monitoring device.

FIG. 4 is a partial configuration diagram of the combustion monitoring device.

FIG. 5 is a flowchart of an information acquisition process.

FIG. 6 is a diagram showing a configuration example of a teaching data table.

FIG. 7 is a diagram showing a configuration example of a comparison data table.

FIG. 8 is a flowchart of a normal range specification process.

FIG. 9 is a graph (a scatter diagram) in which teaching data is plotted on a coordinate system having an amount of fuel as an X axis and an average value of flame levels as a Y axis.

FIG. 10 is a diagram obtained by adding a normal range to the graph of FIG. 9.

FIG. 11 is a graph a scatter diagram) obtained by plotting the teaching data on a coordinate system having the amount of fuel as the X axis and a variation degree of the flame levels as the Y axis, and adding the normal range.

FIG. 12 is a graph (a scatter diagram) obtained by plotting comparison data on a coordinate system having the amount of fuel as the X axis and the average value of the flame levels as the Y axis, and adding the normal range.

FIG. 13 is a graph (a scatter diagram) obtained by plotting the comparison data on a coordinate system having the amount of fuel as the X axis and a variation degree of the flame levels as the Y axis, and adding the normal range.

FIG. 14 is a flowchart of a graph display process.

FIG. 15 is a graph (a scatter diagram) obtained by plotting other comparison data on the coordinate system having the amount of fuel as the X axis and the average value of the flame levels as the Y axis, and adding the normal range.

FIG. 16 is diagram illustrating graphics when the comparison data is plotted.

FIG. 17 is a trend graph showing a temporal change in each of the amount of fuel, the average value of the flame levels, and the variation degree of the flame levels.

### DETAILED DESCRIPTION OF THE INVENTION

Embodiments of the present disclosure will be described below with reference to the drawings.

### Embodiments

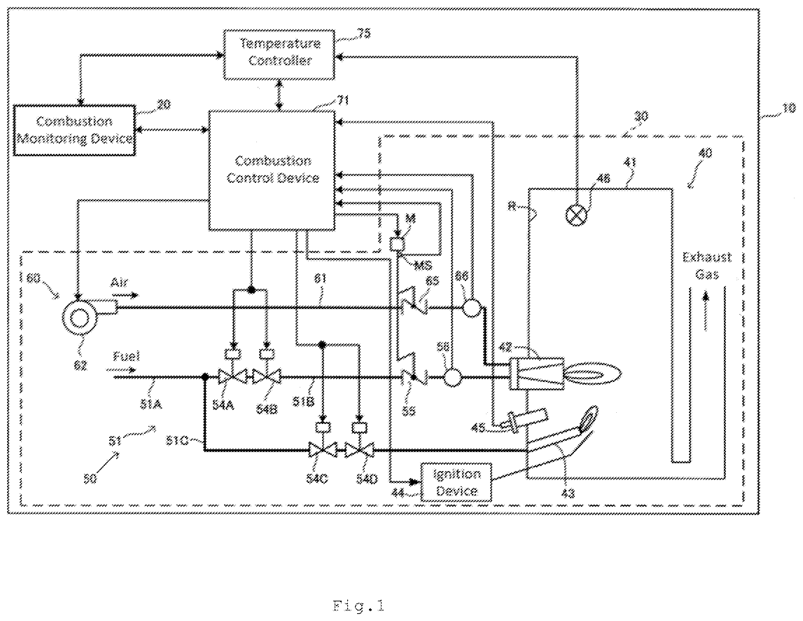

As shown in FIG. 1, a combustion monitoring device 20 according to an embodiment of the present disclosure is used in a combustion system 10. In order to allow a user to appropriately recognize a malfunction (presence or absence of the malfunction and the cause thereof, of which at least the former) of a combustion device 30 of the combustion system 10, the combustion monitoring device 20 monitors an amount of fuel supplied to the combustion device 30, in particular, to a main burner 42, and an active degree (in particular, a flame level) of a flame of the main burner 42. The “malfunction” means a minor abnormality that allows the combustion device 30 to perform heating before the combustion device 30 becomes in a state of a severe abnormality such as a state in which combustion cannot be performed due to flame failure. The malfunction can also be said to be a sign of a severe abnormality. The severe abnormality may occur if the malfunction is left untreated.

The combustion system 10 includes, in addition to the combustion monitoring device 20, the combustion device 30 that performs combustion, a combustion control device 71 that controls the combustion device 30, and a temperature controller 75 that performs various instructions to the combustion control device 71. Hereinafter, the combustion device 30, the combustion control device 71, and the temperature controller 75 will be described first, and then the combustion monitoring device 20 be described.

The combustion device 30 includes a combustion equipment 40, a fuel supply system 50, an air supply system 60, a control motor M, and an opening degree sensor MS.

The combustion equipment 40 combusts a fuel gas inside a combustion chamber R. The combustion equipment includes a combustion furnace 41 that forms the combustion chamber R, the main burner 42 that combusts the fuel gas to heat the inside of the combustion chamber R, a pilot burner 43 that combusts fuel to ignite the main burner 42, and an ignition device (an igniter) 44 that ignites the pilot burner 43.

The combustion equipment 40 further includes a flame detector 45 that detects active degrees of flames of the main burner 42 and the pilot burner 43, and a temperature sensor 46 that detects a temperature inside the combustion chamber R. The active degree of the flame is a degree indicating how actively the flame is generated, and here it is an intensity of the flame. The flame detector 45 includes a discharge tube (for example, an ultraviolet tube) that discharges with electromagnetic waves (for example, ultraviolet rays) radiated from the flame of the main burner 42 or the pilot burner 43. The flame detector 45 detects these electromagnetic waves, that is, the flame by the discharge of the discharge tube when the flame detector 45 receives the electromagnetic waves. A discharge current generated by the discharge is input to the combustion control device 71.

The fuel supply system 50 supplies the fuel gas from the outside to the combustion equipment 40. The fuel supply system 50 includes a fuel flow path 51 through which the fuel gas to be supplied to the combustion equipment 40 flows. The fuel flow path 51 includes a main flow path 51A to which the fuel gas is supplied from the outside, and a first flow path 51B and a second flow path 51C that are branched from the main flow path 51A. The first flow path 51B is connected to the main burner 42, and the second flow path 51C is connected to the pilot burner 43.

The fuel supply system 50 further includes main valves 54A and 54B that are provided in the first flow path 51B, and pilot valves 54C and 54D that are provided in the second flow path 51C. The main valves 54A and 54B open and close the first flow path 51B. The pilot valves 54C and 54D open and close the second flow path 51C. The fuel supply system 50 further includes a damper 55 that is provided in the main flow path 51A and used to adjust a flow rate of fuel, and a fuel flow meter 56 that detects, in the form of a flow rate of a fuel gas, an amount of fuel flowing through the first flow path 51B, that is, an amount of fuel supplied to the main burner 42.

The air supply system 60 supplies air to the combustion equipment 40. The air supply system 60 includes an air flow path 61 that supplies the air to the main burner 42 of the combustion equipment 40 and a blower 62 that causes the air to flow through the air flow path 61. The air supply system 60 further includes a damper 65 that is provided in the air flow path 61 and used to adjust a flow rate of air, and an air flow meter 66 that detects, in the form of the flow rate of air, an amount of air flowing through the air flow path 61, that is, an amount of air supplied to the main burner 42.

The damper 55 used to adjust the flow rate of the fuel and the damper 65 used to adjust the flow rate of the air are operated by the control motor M to control opening degrees of the fuel flow path 51 (the first flow path 51B) and the air flow path 61. The dampers 55 and 65 operate while being interlocked with each other by a linkage mechanism. Accordingly, the opening degrees of the dampers 55 and 65 are interlocked. with each other. The dampers 55 and 65 may be interlocked with each other by another configuration. For example, the damper 65 may be a pressure equalizing valve into which an air pressure in the air flow path 61 of the air supply system 60 is introduced. The damper 65, which is a pressure equalizing valve, operates such that the air pressure in the air flow path 61 and a fuel pressure in the first flow path 51B of the fuel flow path 51 are made uniform.

The opening degrees of the dampers 55 and 65 are interlocked with each other such that an air-fuel ratio, which is a ratio of the air to the fuel that are supplied to the main burner 42, is maintained at a desired ratio. The amounts of fuel and air that are supplied to the main burner 42 are adjusted by the opening degrees of the dampers 55 and 65, whereby the active degree of the flame of each burner is adjusted. As a result, a heating temperature for heating the combustion chamber R is controlled.

The control motor M is provided with the opening degree sensor MS that detects the opening degrees of the dampers 55 and 65 by detecting rotation angles of a rotation shaft or the like. The opening degrees detected by the opening degree sensor MS are used as feedback values when the control motor M is feedback-controlled to control the opening degrees of the dampers 55 and 65.

The combustion control device 71 includes various computers such as a programmable logic controller (PLC) and a personal computer. The combustion control device 71 is also referred to as a burner controller.

The discharge current output when the flame detector 45 detects the flame of the burner 42 or 43, that is, the electromagnetic waves is input to the combustion control device 71. The combustion control device 71 integrates a potential difference or the like between both ends of a resistor through which the discharge current flows, and generates a flame voltage (which may be a flame current, the same applying hereinafter) indicating the active degree of the flame. Further, the combustion control device 71 generates a discharge pulse signal (for example, a voltage signal) indicating discharge based on the potential difference or the like. The combustion control device 71 generates a flame level, which is a numerical value indicating discharge frequency, based on the discharge pulse signal. Specifically, the combustion control device 71 counts the number of discharge pulses, that is, the number of discharge times N per certain time for example, 0.1 seconds or 1 second) based on the discharge pulse signal. The combustion control device 71 derives a flame level F1 expressed by the number of discharge times based on the counted number of discharge times N. A method for deriving the flame level F1 may be any method. Here, the flame level F1 is derived by the following Equation (1). In the equation, Nmax is the maximum number of discharge times per certain time described above. Here, the flame level F1 is represented, percentage, and may be represented by N/Nmax alone.

F1=(N/Nmax)*100 (1)

Both the flame voltage and the flame level are numerical values that indicate the active degree of the flame. The flame voltage is used in the following combustion sequence, and the flame level is used in the combustion monitoring device 20 as described. later. The flame level has better responsiveness to a change in flame than the flame voltage. The flame voltage is used to detect ignition and extinguishment (including flame failure) of the flame of the burner 42 or 43. As will be described later, the flame level is used for monitoring the malfunction of the combustion device 30.

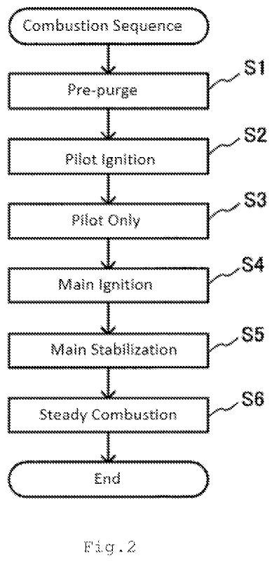

The combustion control device 71 controls the combustion device 30 according to a predetermined combustion sequence to heat the inside of the combustion chamber R. As shown in FIG. 2, the combustion sequence includes subsequences such as “pre-purge” (step S1), “pilot ignition” (step S2), “pilot only” (step 33), “main ignition” (step S4), “main stabilization.” (step S5), and “steady combustion” (step S6). It is assumed that the valves 54A to 54D of the fuel supply system 50 are closed at the start of the combustion sequence.

During pre-purge, the combustion control device 71 drives the control motor M, controls the damper 65 to a high opening degree position, and operates the blower 62 of the air supply system 60. Accordingly, fresh air is blown into the combustion chamber R through the main burner 42, and the fuel gas remaining inside the combustion chamber R is discharged to the outside. The pre-purge is performed for a certain time. When controlling the opening degrees of the dampers 55 and 65, the combustion control device 71 performs feedback control on the control motor M using the opening degrees detected by the opening degree sensor MS as the feedback values (hereafter, the same applies to the control of the opening degree).

After the pre-purge, the combustion control device 71 controls the dampers 55 and 65 to a low opening degree position. Thereafter, the combustion control device 71 controls the pilot valves 54C and 54D of the fuel supply system 50 to be is an open state to start fuel supply to the pilot burner 43, and operates the ignition device 44 to perform pilot ignition for generating an ignition spark. Accordingly, the pilot burner 43 is ignited. The combustion control device 71 detects ignition of the pilot burner 43 when the above flame voltage (the active degree of the flame) is more than a predetermined value. After the detection, the combustion control device 71 waits for a predetermined period to perform the “pilot only” to stabilize the flame of the pilot burner 43.

After the “pilot only”, the combustion control device 71 performs main ignition in which the main valves 54A and 54B of the fuel supply system 50 are controlled to an open state to start fuel supply to the main burner 42. Accordingly, the main burner 42 is ignited using the flame of the pilot burner 43 as a pilot light. The combustion control device 71 closes the pilot valves 54C and 54D of the fuel supply system 50 and extinguishes the flame of the pilot burner 43, assuming that the main ignition is con ted after a predetermined period has elapsed since the main valves 54A and 54B are opened. Thereafter, in order to stabilize the flame of the main burner 42, the combustion control device 71 performs the main stabilization of waiting for a predetermined period.

After the main stabilization, the combustion control device 71 shifts to steady combustion. The inside of the combustion chamber R is heated by steady combustion of the main burner 42. During the steady combustion, the combustion control device 71 controls the opening degrees of the dampers 55 and 65 via the control motor M to control flow rates of the air and the fuel to the main burner 42. Accordingly, a firepower (the active degree of the flame) of the main burner 42 is controlled (details will be described later). The combustion control device 71 closes the main valves 54A and 54B of the fuel supply system 50 to extinguish the flame of the main burner 42 at a timing of the end of the steady combustion. A post-purge may be performed after the steady combustion.

The combustion control device 71 stores a sequence number indicating whether the combustion sequence is currently being performed and the subsequence when the combustion sequence is being executed. For example, when the combustion sequence is not executed, “0” is assigned as the sequence number. In the pre-purge, the pilot ignition, the pilot only, the main ignition, the main stabilization, and the stead combustion which are subsequences, the numbers “1” to “6” are assigned as sequence numbers. The combustion control device 71 updates a sequence number stored in the combustion control device 71 based on the start of execution of the combustion sequence, the switching of the subsequence, and the like.

Referring back to FIG. 1, the temperature controller 75 instructs the combustion control device 71 to start the combustion sequence and end the steady combustion (an end timing of the combustion sequence). Further, the temperature controller 75 instructs the combustion control device 71 such that the temperature inside the combustion chamber R becomes a target temperature, using a temperature detected by the temperature sensor 46 as a feedback value. The temperature controller 75 gives instructions on the flow rates of the fuel and the air during the steady combustion, and the like, based on a relation between the feedback value and the target temperature. When giving instructions on the flow rates of the fuel and the air, the temperature controller 75 supplies the flow rates to the combustion control device 71 as target values. The combustion control device 71 derives a target opening degree from the supplied target values, and performs feedback control on the control motor M using the opening degrees from the opening degree sensor MS as feedback values such that the opening degrees of the dampers 55 and 65 become the target opening degree. The combustion control device 71 may control the opening degrees by feedback control using, as feedback values, the amounts of fuel and air to the main burner 42 that are respectively detected by the flow meters 56 and 66.

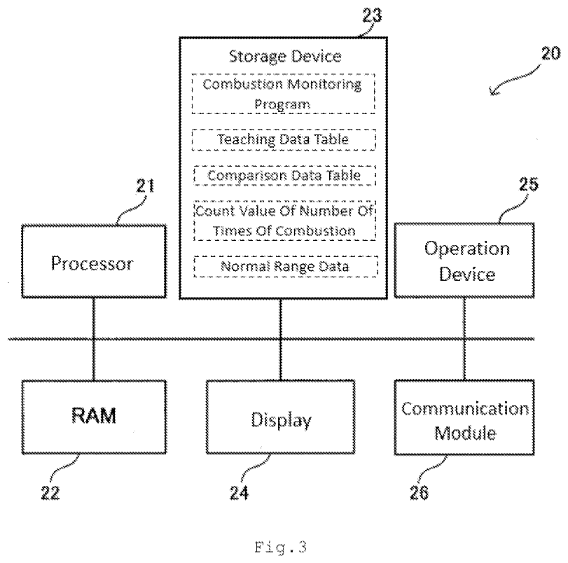

The combustion monitoring device 20 shown in FIG. 1 includes various computers such as a personal computer. shown in FIG. 3, the combustion monitoring device 20 includes a processor 21 such as a central processing unit (CPU), a random access memory (RAM) 22 that functions as a main memory of the processor 21, and a non-volatile storage device 23 that stores a combustion monitoring program executed by the processor 21. The storage device 23 also stores a teaching data table, a comparison data table, a count value of the number of times of combustion, and normal range data (details will be described later). The combustion monitoring device 20 further includes a display 24 that displays various screens to be described later, an operation device 25 operated by the user, and a communication module 26 that causes the processor 21 to communicate with the combustion control device 71 and the temperature controller 75.

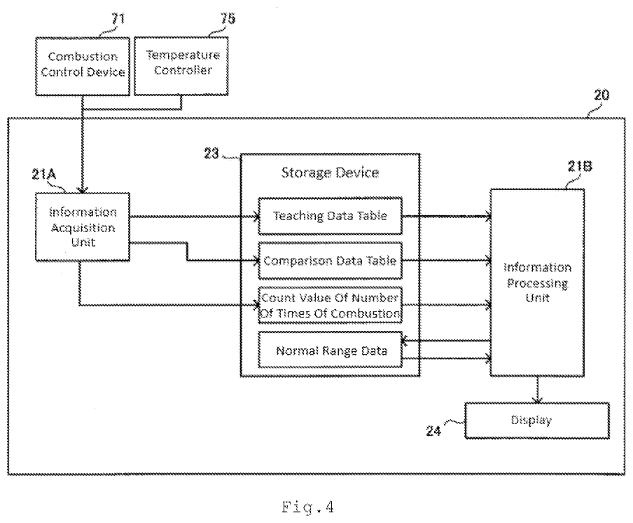

in the embodiment, the processor 21 operates as an information acquisition unit 21A and an information processing unit 21B shown in FIG. 4 by executing the combustion monitoring program stored in the storage device 23.

The information acquisition unit 21A functions as a data collector that collects various types of data from the combustion control device 71, the temperature controller 75, and the like periodically (for example, every 0.1 seconds or 1 second) and that stores the collected data in the storage device 23 together with a date and time. The date and time may be given by the information acquisition unit 21A. as an acquisition date and time of various types of data, or may be supplied from the combustion control device 71 as the date and time when the combustion control device 71 or the like acquires various types of data. The various types of data acquired by the information acquisition unit 21A include the amount of fuel and the flame level from the combustion control device 71. The amount of fuel is an amount of fuel to the main burner 42 and is detected by the fuel flow meter 56. The information acquisition unit 21A derives an average value and a variation degree of flame levels in a predetermined period (for example, 5 seconds among the periodically collected flame levels. The variation degree is a degree of variation in a plurality of flame level in the predetermined period, and is, for example, a variance or a standard deviation. Thus, the information acquisition unit 21A acquires the average value and the variation degree of the flame levels in addition to the amount of fuel.

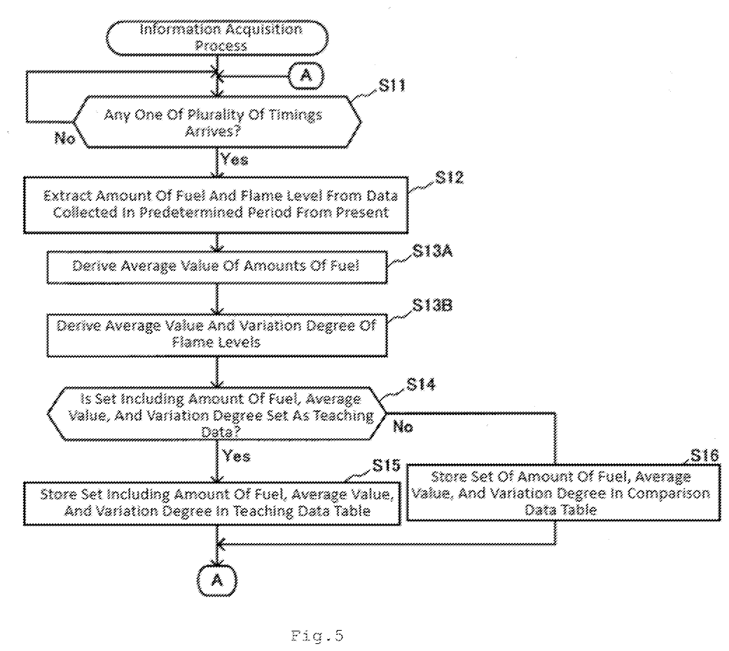

The information acquisition unit 21A executes an information acquisition process shown in FIG. 5 as a process of acquiring the amount of fuel, and the average value and the variation degree of the flame levels. The information acquisition unit 21A communicates with the combustion control device 71, monitors the sequence number stored in the combustion control device 71, and performs the process shown in FIG. 5 when it is detected that the sequence number changes from “4” (main ignition) to “5” (main stabilization). Further, when the sequence number changes from “0” to “1”, the information acquisition unit 21A increments the count value of the number of times of combustion stored in the storage device 23 by 1. Accordingly, the total number of times of execution of the combustion sequence from the start of operation of the combustion system 10, that is, the total number of times of combustion is counted. As another example, the information acquisition unit 21A may count the total number of times of combustion (the total number of times of combustion in which the steady combustion is performed) by increasing the count value of the number of times of combustion by 1 when the sequence number changes to “6” (the steady combustion). As described above, the count value of the number of times of combustion indicates the total number of times of combustion. The information acquisition process shown in FIG. 5 ends when the sequence number changes from “6” to “0”.

In the information acquisition process shown in FIG. 5, the information acquisition unit 21A waits until any one a plurality of predetermined timings in the main stabilization or the steady combustion arrives (step S11). The information acquisition unit 21A measures an elapsed time from a timing at which the sequence number changes to “5”, and determines that any one of the plurality of timings has arrived when the measured elapsed time reaches any one of the plurality of timings.

When any one of the plurality of timings has arrived (step S11; Yes), the information acquisition unit 21A buffers various types of data collected at regular intervals (for example, every second) in a predetermined period (here, 5 seconds) that is started from the present, and extracts the amount of fuel and the flame level from the various types of buffered data (step S12).

The information acquisition unit 21A calculates an average of the plurality of extracted amounts of fuel, and derives an average value of the plurality of amounts of fuel in the predetermined period (step S13A). The information acquisition unit 21A further derives an average value and a variation degree of the plurality of flame levels in the predetermined period by calculating an average value and a variation degree of the plurality of extracted flame levels (step S13B). In stags S13A and S13B, the information acquisition unit 21A acquires the amount (here, the average value) of fuel and the average value and the variation degree of the flame levels in the case of the amount of fuel. The amount of fuel may be, in addition to the average value in the above predetermined period, any one (a representative value, a median value, or the like) of a plurality of fuel flow rates in the above predetermined period, a total value, or the like. As described above, the amount of fuel may be a value indicating the magnitude of an amount of the fuel gas in the above predetermined period.

The information acquisition unit 21A determines whether the acquired amount of fuel and the average, value and the variation degree of the flame levels should be set as teaching data for defining a normal range (details will be described later) of a set including the amount of fuel and the average value and the variation degree of the flame levels (step S14). When the current count value of the number of times of combustion is equal to or less than a predetermined value, the information acquisition unit 21A determines the acquired set to be teaching data. The predetermined value is set in advance as the number of times of combustion that ensures that the combustion system 10 (in particular, the combustion device 30) still operates normally. Therefore, the teaching data is data of a set of the amount of fuel and the average value and the variation degree of the flame levels when the combustion system 10 operates normally.

When the acquired set is to be used as the teaching date (step S14; Yes), the information acquisition unit 21A stores the set in the teaching data table of the storage device 23 (step S15). In this case, the acquisition date and time of the scat and the number of times of combustion (the count value of the number of times of combustion) are also stored together with the set. The acquisition date and time may be a current date and time acquired by referring to a calendar unit or the like at the timing when the information acquisition unit 21A derives the average value of the flame levels or the like, or a date and time related to the date and time, for example, a date and time sequentially supplied together with data such as an amount of fuel from the combustion control device 71 in the above predetermined period. Instead of the average value of the flame levels, any one (a median value, a representative value, or the like) of the plurality of flame levels in the predetermined period may be adopted (hereinafter, the same applies to the average value).

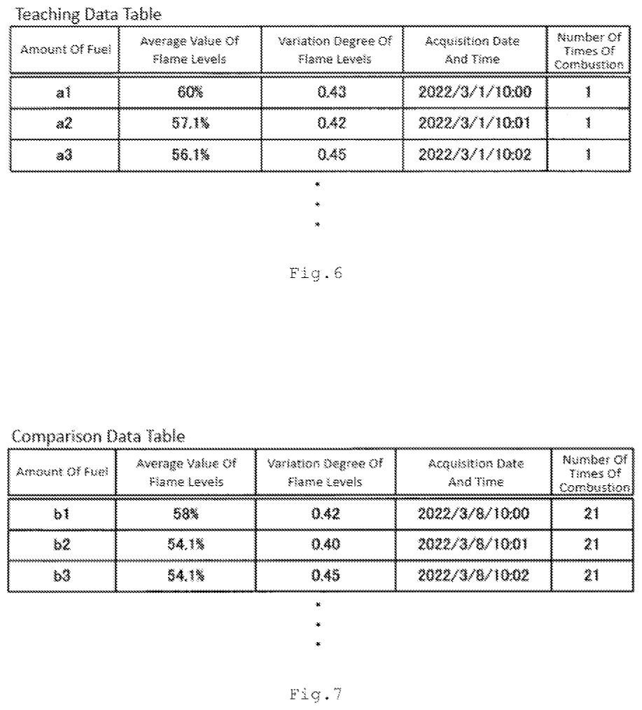

As shown in FIG. 6, the teaching data table stores the amount of fuel, the average value of the flame levels, the variation degree of the flame levels, the acquisition date and time, and the number of times of combustion in association with one another.

When the current count value of the number of times of combustion is more than the predetermined value, the information acquisition unit 21A determines that the acquired set is, instead of the teaching data, comparison data to be compared and displayed with the normal range based on the teaching data (step S14; No). In this case, the information at unit 21A stores the set in the comparison data table provided in the storage device 23 (step S16). In this case, the acquisition date and time of the set and the number of times of combustion (the count value of the number of times of combustion) are also stored together with the set.

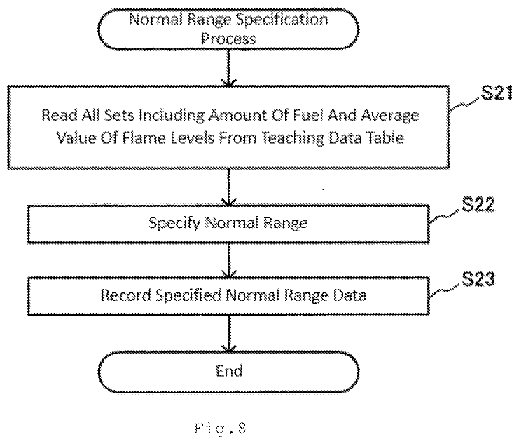

As shown in FIG. 7, the comparison data table stores the amount of fuel, the average value of the flame levels, the variation degree of the flame levels, the acquisition date and time, and the number of times of combustion in association with one another.

After step S15 or S16, the information acquisition unit 21A executes the process in step S11 again.

Referring back to FIG. 4, the information processing unit 21B executes, based on the teaching data in the teaching data table, normal range specification process of specifying a normal range as a range of possible values for the amount of fuel and the average value of the flame levels in the case of the amount of fuel when the combustion system 10 (in particular, the combustion device 30) operates normally. This process is executed when a certain number of pieces of teaching data are stored in the teaching data table.

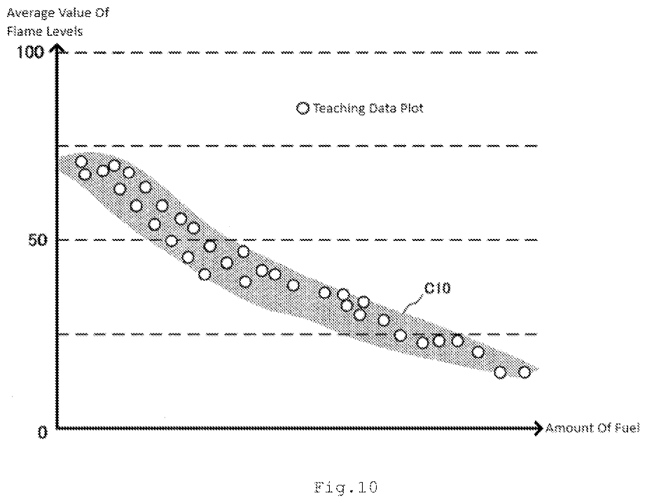

The information processing unit 21B executes a process shown in FIG. 8 as the normal range specification process. In the process, the information processing unit 21B first reads all pieces of teaching data including a set of the amount of fuel and the average value of the flame levels associated with the amount of fuel (step S21). The teaching data is recorded in the teaching data table. Thereafter, the information processing unit 21B specifies a normal range C10 (see FIG. 10) based on all the read sets (step S22).

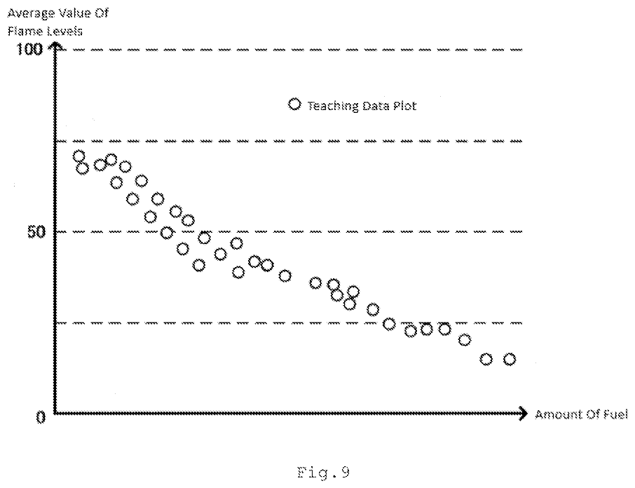

The normal range C10 is specified by any method. For example, the information processing unit 21B divides the amount of fuel for each constant section, specifies a normal range of the average value of the flame levels using Kernel Density Estimation or the like for each section, and connects the normal range for each section to set the entire normal range C10. When the number of pieces of teaching data used for specifying the normal range is small, the information processing unit 21B may increase the teaching data by any method. As another example, the information processing unit 21B may generate a graph (see FIG. 9) in which all the read sets are plotted in an orthogonal coordinate system having the amount of fuel as an X axis and the average value of the flame levels as a Y axis, and may display the generated graph on the display 24. In this case, the user who views the graph may operate the operation device 25 to specify the normal range C10 on the display 24. The information processing unit 21B specifies the specified range as the normal range C10. FIG. 10 shows a graph in which the normal range C10 is set. The number of plots in each graph in FIGS. 9 and 10 is drawn with less than the actual number (the same applies to other graphs).

The information processing unit 21B records, in the storage device 23, the normal range data indicating the specified normal range C10 (step S23).

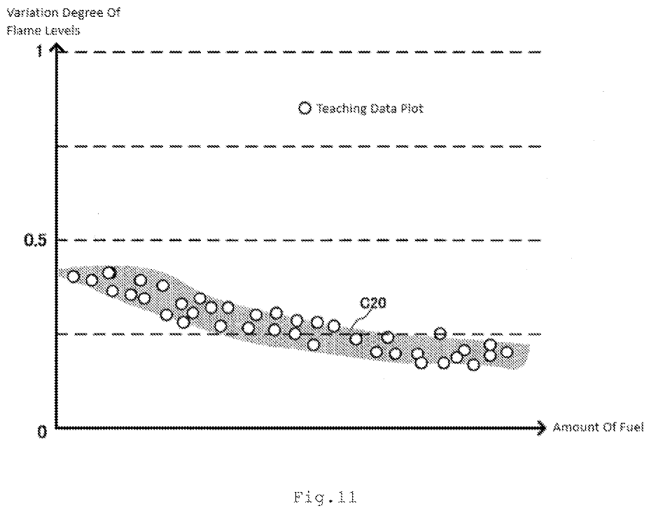

Alternatively or additionally, the information processing unit 21B executes, based on the teaching data in the teaching data table, a process of specifying a normal range C20 as a possible range of values for the amount of fuel and the variation degree of the flame levels in the case of the amount of fuel when the combustion system 10 (in particular, the combustion device 30) operates normally. The description of the process is the same as the description. of the process of specifying the normal range C10 for the average value of the flame levels (the average value is replaced with the variation degree). FIG. 11 shows a graph in which the normal range C20 is set.

As described above, the information processing unit 21B specifies the normal range C10 of the set of the amount of fuel and the average value of the flame levels and the normal range C20 of the set of the amount of fuel and the variation degree of the flame levels.

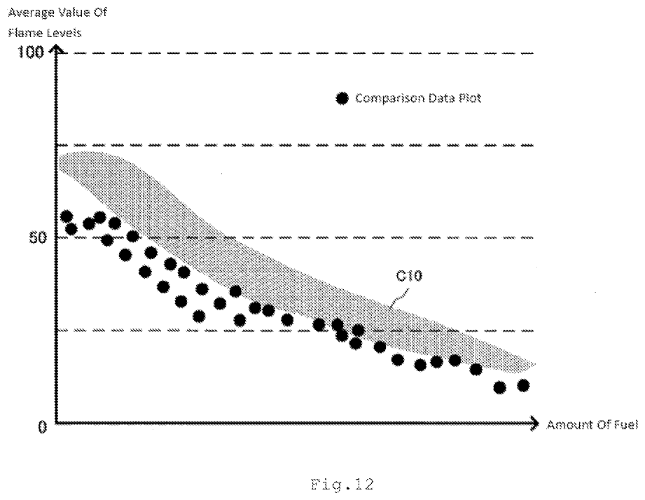

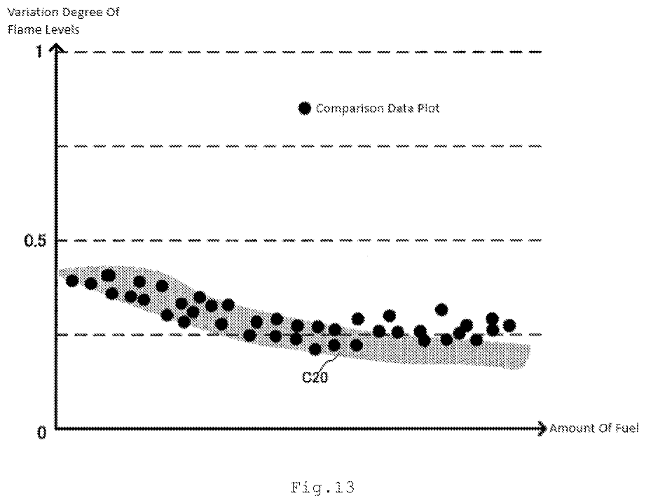

The information processing unit 21B in FIG. 4 further plots, in the orthogonal coordinate system, at least a part and a plurality of sets of all sets each including the amount of fuel and the average value and the variation degree of the flame levels associated with the flow rate, and generates a graph (see FIGS. 12 and 13) in which the plurality of sets are plotted. All the sets are recorded in the comparison data table. Here, a first graph (FIG. 12) having the average value of the flame levels as a vertical axis and a second graph (FIG. 13) having the variation degree of the flame levels as a vertical axis are generated. The normal range C10 is also displayed in the first graph, and the normal range C20 is also displayed in the second graph. The information processing unit 21B displays the generated first graph and second graph on the display 24.

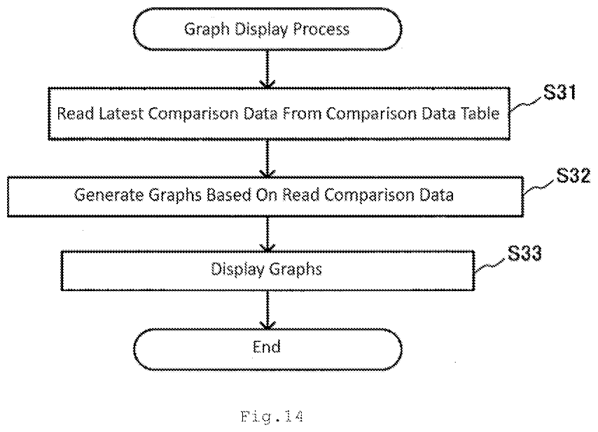

The information processing unit 21B executes, for example, a graph display process shown in FIG. 14 for the display of the above graphs. This process is started at any timing (for example, when an instruction to display a graph is input to the operation device 25) after the specification of the normal ranges C10 and C20.

The information processing unit 21B first reads, among the comparison data (the set of the amount of fuel, the average value of the flame levels, and the variation degree of the flame levels) recorded in the comparison data table, comparison data corresponding to the date and time or the number of time of combustion within a period preceding the current time by a certain time or preceding the highest number of times of combustion by a certain number of times as latest comparison data (step S31). The information processing unit 21B generates a graph in which the read recent comparison data is plotted in the orthogonal coordinate system and in which the plotted comparison data (hereinafter, also referred to as a comparison data plot) and the specified normal ranges C10 and C20 are displayed in a superimposed manner, that is, the first graph and the second graph as shown in FIGS. 12 and 13 (step S32). The information processing unit 21B displays the generated graphs on the display 24 (step S33).

When the use views the graphs displayed on the display 24, the user compares the plotted comparison data plot with the normal range C10 or C20 to determine whether a malfunction has occurred in the combustion device 30. When the comparison date plot is within the normal range, the combustion device 30 is operating normally and no malfunction has occurred. When a certain number or more of comparison data plots among all the comparison data plots are outside the normal range C10 or C20 as shown in FIGS. 12 and 13, it is determined that a malfunction has occurred in the combustion device 30.

The average value of the flame levels is related to the intensity of the ultraviolet rays from the flame, and is also related to the active degree of the flame, a defect of the flame detector 45, and the like. As an example of the defect of the flame detector 45, a window of the flame detector 45 that transmits an electromagnetic wave from a flame and guides the electromagnetic wave to a discharge tube may be dirty, or the flame detector 45 may be displaced and the window may be oriented in such a way that the ultraviolet rays are less likely to enter. Due to these defects, the average value of the flame levels decreases as a whole over the entire amount of fuel. FIG. 12 shows this state. Therefore, according to the graph in FIG. 12, the user can recognize the malfunction of the combustion device 30 that has occurred due to the defect of the flame detector 45. The air-fuel ratio may deteriorate as a whole due to a defect of the linkage mechanism or the like, and the average value of the flame levels may decrease as a whole over the total amount of fuel. When this case is considered, according to the graph in FIG. 12, the user can recognize the malfunction of the combustion device 30 that has occurred due to the defect of the flame detector 45 or the deterioration of the air-fuel ratio.

The variation degree of the flame level is increased when the flame is not stabilized (including lift of the flame and the like). A reason for the phenomenon that the flame is not stabilized is fluctuations in the amounts of fuel and air due to a defect of the damper 55 or 65 or the like. In the example in FIG. 13, the flame is not stabilized in a region where the amount of fuel is large. In the graph in FIG. 13, the user can recognize a malfunction in which the flame is not stabilized in the region where the amount of fuel is large, and that the fluctuations in the amount of fuel or the amount of air and the like are candidates for the reason.

When the amount of fuel changes, a flame shape if the main burner 42 also changes. When the average value of the flame levels tends to be large, flame monitoring can be reliably performed, and when the average value of the flame levels tends to be small, a misfire is likely to occur. On the other hand, the flame monitoring can be performed more reliably when the variation degree of the flame levels is smaller. By combining the average value and the variation degree, it is possible to visualize fuel amount points at which flame monitoring is easy or difficult, and extent of flame stabilization at those points, and by analyzing the fuel amount points and the flame stabilization, it is possible to check an amount of fuel in which the misfire is likely to occur (or it is difficult to detect the flame) and an amount of fuel in which the flame is not stable.

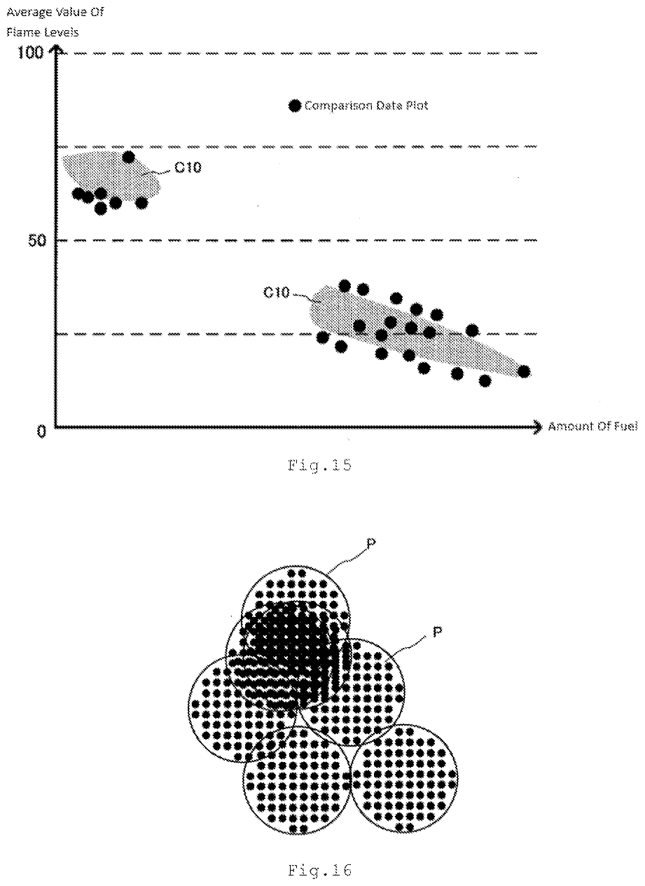

The teaching data and the comparison data may be acquired only in a main stabilization period (a period in which the amount of fuel is small) and a period in which the subsequent steady combustion is stabilized in the combustion sequence (a period in which the amount of fuel is large). A graph at these periods is shown in FIG. 15. FIG. 15 is a graph of the average value of the flame levels, and the same applies to the variation degree. It is possible to recognize the malfunction even with these graphs. For example, in the example in FIG. 15, a variation in plotting positions of the comparison data plots is larger than that in the normal range, suggesting that a malfunction has occurred.

As described above, in this embodiment, the information acquisition unit 21A acquires a plurality of sets (the comparison data, in particular, the latest comparison data read in step 231) of the amount of fuel supplied to the main burner 42 of the combustion device 30, and the average value of the flame levels and the variation degree of the flame level when the amount of fuel is supplied to the main burner 42. The information processing unit 21B executes a process of displaying, on the display 24, the first graph (FIG. 12) indicating a relation between the amount of fuel and the average value of the flame levels, and the second graph (FIG. 13) indicating a relation between the amount of fuel and the variation degree of the flame levels, based on the plurality of sets acquired by the information acquisition unit 21A. Accordingly, the user who has checked the graphs can appropriately recognize whether a malfunction has occurred in the combustion device 30 according to the positions of the plotted comparison data plots, particularly here, by the comparisons with the normal ranges C10 and C20. In particular, the user can recognize a malfunction that cannot be recognized by monitoring only the active degree of the flame of the main burner 42, for example, a defect of the flame detector 45 that cart be seen from a decrease in the average value of the flame levels that extends over the entire amount of fuel, and a malfunction such as an unstable flame at a certain amount of fuel.

As is clear from FIGS. 2 and 13, since ranges of the normal ranges C10 and C20 change according to a value of the amount of fuel, the normal range is appropriately set, and the user can appropriately recognize the presence or absence of a malfunction.

The active degree described above is represented by the number of discharges per predetermined time in the flame detector 45 caused by the flame of the burner (the flame level). Such an active degree has good responsiveness to a change in flame, and is suitable for capturing change (particularly, the variation degree) in flame.

Information used for the comparison data and the teaching data may be, for example, the magnitude of the active degree and the variation degree of the flame of the main burner 42. The active degree may be represented by a flame voltage or the like in addition to the flame level. The magnitude of the active degree may be a value that increases or decreases depending on the magnitude of the active degree, and may be the active degree per se. Examples of the magnitude of the active degree include an average value of the flame levels, a representative value or a median value of the flame levels in the predetermined period, and a flame level at a certain timing.

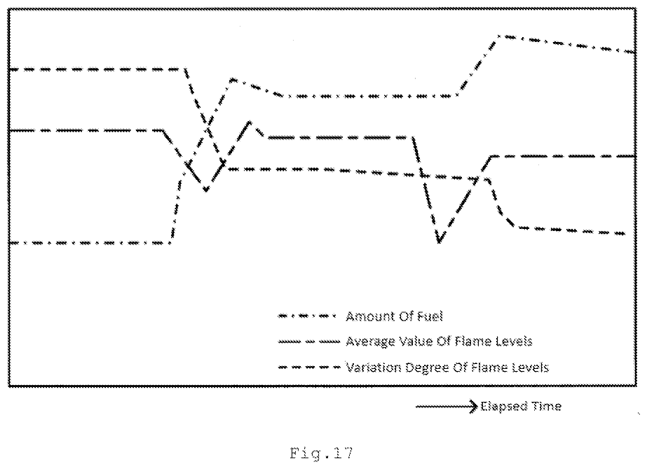

The information processing unit 21B plots each of the plurality of sets, which are the plurality of pieces of comparison data, on a graphic (here, in a circle) in a coordinate system, and each of a plurality of graphics P (the comparison data plots) plotted as shown in FIG. 16 may be translucent such that a color of an overlapping portion is dark when the graphics P are plotted in an overlapping manner. Accordingly, it can be understood that the sets are concentrated in a portion where the color is dark, and for example, when there is a portion where the color is dark outside the normal range C10 or C20, the user can recognize that a possibility of occurrence of the above malfunction is high. Variations of the flame level are represented by plotting, as a scatter diagram as shown in FIG. 12, the sets each including the magnitude of the active degree such as the average value of the flame levels and the amount of fuel. When the plotted sets include the magnitude of the active degree (in particular, not the average value but a representative value of the flame level or the flame level at a certain timing), a distribution, an average, and the like of the active degrees for each amount of fuel are recognized according to shades of the color.

The teaching data, the comparison data, the normal range, and the like may be divided according to types and/or amounts of workpieces to be heated in the combustion chamber R. For example, since the types and amounts of the workpieces con be specified based on a past operation result of the combustion device 30, records constituting the teaching data table and the comparison data table are divided for the types and/or amounts of the workpieces based on the acquisition date and time or the number of times of combustion. The specification for the normal range and the plots on the graphs may be separately performed for each piece of data divided by the types and/or amounts of the workpieces. Accordingly, the above graphs are generated for each of the types and or amounts of the workpieces. By comparing the graphs, the malfunction can be recognized in more detail, and the types and/or amounts of workpieces that are compatible with the combustion device 30 (good combustion efficiency or the like) can be recognized. By dividing the comparison data into a plurality of groups in chronological order and generating graphs for the groups, the deterioration of the combustion device over time can also be recognized. Further, by dividing the graphs according to the types and/or amounts of the workpieces, it is possible to recognize how deterioration progresses over time for each of the workpieces.

### (Modifications)

A configuration of the above embodiment can be freely changed. Modifications are exemplified below. The modifications can be combined at least partially.

### (Modification 1)

A configuration of the combustion device 30 may he freely set. For example, the combustion device 30 may be of a type including only the main burner 42 without the pilot burner 43. In addition, the combustion device 30 may be in a state in which the pilot burner 43 is always ignited. In this case, a flame detector for the main burner 42 and a flame detector for the pilot burner 43 may be prepared.

### (Modification 2)

The first graph and the second graph may be displayed in a superimposed manner. The normal range C10 or C20 may not be displayed in the graphs. Even if there is no normal range, the user can appropriately recognize the malfunction of the combustion device 30 depending on positions of the plotted comparison data plots in the graph or the variation degree of a plurality of comparison data plots.

### (Modification 3)

Information acquired by the information acquisition unit 21A may be only one of the magnitude of the active degree and the variation degree of the flame. The displayed graph may be on ay one of the first graph and the second graph described above. Accordingly, the user can appropriately recognize the malfunction of the combustion device 30.

### (Modification 4)

The normal ranges C10 and C20 may be set in advance by a user or the like, regardless of the teaching data, that is, the sets each including the amount of fuel and the magnitude of the active degree and the variation degree of the flame that are acquired when the combustion device 30 is operating normally. However, when the teaching data is used, the individual propensities of the combustion device 30 are reflected, and the user can more appropriately recognize the malfunction.

### (Modification 5)

The above sets adopted as teaching data and comparison data may be limited when a temperature of the combustion chamber R is high. When there is a sudden abnormal value in the sets adopted as teaching data or comparison data, the sets may be deleted without being adopted.

### (Modification 6)

The normal range may be represented by a plurality of stages of normal ranges having different threshold values determined to be normal. For example, a normal range wider than the normal range C10 may be displayed on the normal range C10 in a superimposed manner.

### (Modification 7)

In addition to or instead of the above graphs, as another graph indicating a relation of the amount of fuel, the magnitude of the active degree of the flame, and the variation degree of the active degree, the information processing unit 21B may execute a process of displaying a trend graph representing a temporal change in each of the amount of fuel, the magnitude of the active degree of the flame, and the variation degree of the active degree. For example, as shown in FIG. 17, the information processing unit 21B displays, on the display 24, a trend graph indicating a temporal change in each of the amount of fuel, the average value of the flame levels, and the variation degree of the flame levels based on the comparison data and the like. In this trend graph, the amount of fuel, the average value of the flame levels, and the variation degree of the flame levels of the same row (a record) in the comparison data table are arranged at the same time, that is, along a vertical axis.

According to the above trend graph, the user can check the presence or absence of variation in the amount of fuel when the average value or the variation degree of the flame levels greatly changes. The user can also check whether the variation of the latter causes the former to vary, or whether the latter does not vary but the former varies. The user can recognize the possibility of a malfunction when the trend graph includes a period in which the latter does not vary but the former varies. Thus, the user can appropriately recognize the malfunction of the combustion device 30 based on the temporal change. According to the trend graph, the behavior of the flame is known, and it is possible to effectively manage the combustion device 30, including the recognition of a malfunction.

### (Modification 8)

The information processing unit 21B may determine that the combustion device 30 is not operating normally, that is, a malfunction has occurred when a predetermined number or more sets of the plurality of sets (the comparison data) acquired by the information acquisition unit 21A are outside a predetermined normal range such as the normal range C10 or C20, and may output the determination. For example, when generating the first graph and the second graph, the information processing unit 21B counts the number of sets (the comparison data plots) plotted outside the normal range C10 or C20 for each graph, determines that a malfunction has occurred when the number of counts in the first graph or the second graph or sum of the numbers of counts is a predetermined number or more, and outputs (for example, reports) the determination to the outside. For example, the information processing unit 21B displays the determination on the display 24, outputs a sound by a speaker (not shown) or the like, or outputs to another device. As described above, since a type and/or a cause of the malfunction can be known depending on how the comparison data plots deviate from the normal range C10 or C20, the information processing unit 21B may learn relation between how the comparison data plots deviate and the type and/or the cause of the malfunction by machine learning or the like, and may output the type and/or the cause of the malfunction to the outside when the malfunction is output to the outside.

The information processing unit 21B may not execute the process of displaying the graphs. The combustion monitoring device 20 may include the information acquisition unit 21A that acquires a plurality of sets each including the amount of fuel and at least one of the active degree of the flame of the main burner 42 and the variation degree of the active degree, and the information processing unit 21B that determines that the combustion device 30 is not operating normally when a predetermined number or more sets of the plurality of sets acquired by the information acquisition unit 21A are outside a predetermined normal range, and that outputs the determination.

### (Modification 9)

The information acquisition unit 21A may acquire, from the combustion control device 71, a valve opening degree detected by the opening degree sensor MS, an operation amount input to the control motor M, or the like, and may derive a CV value (a capacitance coefficient) in the case of the acquired value. In this case, the information acquisition unit 21A may derive the amount of fuel by a known method based on the derived CV value. In this case, two pressure sensors that each measure a respective one of a pressure of the fuel gas on a primary side of the damper 55 and a pressure of the fuel gas on a secondary side of the damper 55 are provided. The information acquisition unit 21A acquires the pressures measured by the two pressure sensors via the combustion control device 71 or the like, and derives an amount of fuel, which is the flow rate of the fuel gas, based on the acquired pressures in addition to the CV value. The amount of fuel may be represented by an amount whose increase or decrease is interlocked with the increase or decrease of the amount of fuel, such as the above-described operation amount or valve opening degree to be fed back.

### (Modification 10)

The dampers 55 and 65 may be individually controlled by the combustion control device 71. In this case, the opening degrees may also be controlled such that the opening degrees have a constant ratio.

### (Modification 11)

The information processing unit 218 may execute, for example, the process of displaying the above various graphs on a display unit. Therefore, the information processing unit 21B may display a graph on an external device such as a display terminal of the user. Further, as another example, as the process, the information processing unit 21B may execute a process of transmitting a plurality of pieces of comparison data, data in a normal range, and the like to the external device without generating a graph, and may execute a process of generating and displaying a graph on the external device.

### (Modification 12)

Other fuels such as a liquid fuel and a gas-liquid mixed fuel may be used instead of the fuel gas.

### (Modification 13)

A hardware configuration of the combustion monitoring device 20 may be freely set. The combustion monitoring device 20 may be formed as a gateway that connects the combustion control device 71 and the temperature controller 75 to other external devices. At least a part of the information acquisition unit 21A and the information processing unit 21B may include various logic circuits such as an application specific integrated circuit (ASIC) and a field-programmable gate array (FPGA). At least a part of the information acquisition unit 21A and the information processing unit 21B may be provided with the combustion control device 71 or the temperature controller 75. The combination monitoring device 20 may be a server computer, a cloud computer, or the like. Each device such as the combustion monitoring device 20 may include, in addition to a device in which components of the device are integrated into a single housing, a system in which the components of the device are distributed and housed in a plurality of housings. The combustion monitoring program may be stored in a non-transitory computer-readable storage medium such as the above storage device 23. The above status values and the like may be recorded in another storage unit such as a RAM, which is a volatile storage device, only for a predetermined period.

### (Scope of the Present Disclosure)

Although the present disclosure has been described with reference to the embodiment and modifications, the present disclosure is not limited to the above embodiment and modifications. For example, the present disclosure includes various variations to the above embodiment and modifications that can be understood by those skilled in the art within the scope of the technical idea of the present disclosure. The configurations described in the above embodiment and modifications can be appropriately combined within a consistent range.

1. A combustion monitoring device comprising:
an information acquisition unit configured to acquire a plurality of sets each including an amount of fuel supplied to a burner of a combustion device and at least one of a magnitude of an active degree of a flame of the burner when the amount of fuel is supplied to the burner and a variation degree of the active degree; and
an information processing unit configured to execute a process of displaying, on a display unit, a graph indicating a relation between the amount of fuel and at least one of the magnitude and the variation degree based on the plurality of sets acquired by the information acquisition unit.

2. The combustion monitoring device according to claim 1, wherein
the active degree is represented by the number of flame detector discharges per unit time caused by the flame of the burner.

3. The combustion monitoring device according to claim 1, wherein
each of the plurality of sets includes both the magnitude and the variation degree, and
the graph includes a first graph in which the amount of fuel and the magnitude are plotted in a coordinate system having the amount of fuel as a first axis and the magnitude as a second axis, and a second graph in which the amount of fuel and the variation degree are plotted in a coordinate system having the amount of fuel as a first axis and the variation degree as a second axis.

4. The combustion monitoring device according to claim 3, wherein
each of the first graph and the second graph shows a normal range when the combustion device operates normally.

5. The combustion monitoring device according to claim 4, wherein
the information acquisition unit is further configured to acquire a plurality of sets each including the amount of fuel, the magnitude, and the variation degree when the combustion device operates normally, and
the information processing unit is further configured to specify the normal range based on the plurality of sets.

6. The combustion monitoring device according to claim 1, wherein
the graph is a graph in which the plurality of sets are plotted on a coordinate system having the amount of fuel as a first axis and at least one of the magnitude and the variation degree as a second axis,
the information processing unit is further configured to plot the plurality of sets on the coordinate system using a plurality of graphics, and
the plurality of graphics are translucent such that, when the graphics are plotted in an overlapping manner, a color of an overlapped portion is dark.

7. The combustion monitoring device according to claim 1, wherein
each of the plurality of sets includes both the magnitude and the variation degree, and
the graph includes a trend graph representing a temporal change in each of the amount of fuel, the magnitude, and the variation degree.

8. The combustion monitoring device according to claim 1, wherein
the information processing unit is further configured to determine that the combustion device is not operating normally when a predetermined number or more sets of the plurality of sets are outside a predetermined normal range, and to output the determination.

9. A non-transitory computer-readable storage medium storing a combustion monitoring program for causing a computer to execute:
an information acquisition step of acquiring plurality of sets each including an amount of fuel supplied to a burner of a combustion device and at least one of a magnitude of an active degree of a flame of the burner when the amount of fuel is supplied to the burner and a variation degree of the active degree; and
an information processing step of executing a process of displaying, on a display unit, a graph indicating a relation between the amount of fuel and at least one of the magnitude and the variation degree based on the plurality of sets acquired in the information acquisition step.

10. The non-transitory computer-readable storage medium according to claim 9, wherein
the information processing step further includes a step of determining that the combustion device is not operating normally when a predetermined number or more sets of the plurality of sets are outside a predetermined normal range, and outputting the determination.
